(19) United States
(12) Patent Application Publication
(10) Pub. No.: US 2013/0191897 A1
(43) Pub. Date: Jul. 25, 2013

(54) Field Provisioning a Device to a Secure Enclave

(71) Applicant: CUMMINGS ENGINEERING CONSULTANTS, INC., Chandler, AZ (US)

(72) Inventors: Ty Brendan Lindteigen, Chandler, AZ (US); James Chester Jones, Chandler, AZ (US)

(73) Assignee: CUMMINGS ENGINEERING CONSULTANTS, INC., Chandler, AZ (US)

(21) Appl. No.: 13/730,311

(22) Filed: Dec. 28, 2012

Related U.S. Application Data
(60) Provisional application No. 61/632,456, filed on Jan. 24, 2012.

(51) Int. Cl. G06F 21/45

(52) U.S. Cl. CPC G06F 21/45
USPC 726/6

(57) ABSTRACT

This invention includes apparatus, systems, and methods to add a new device to a secure enclave, without requiring the new device to enter close proximity to the security entity and protected area. A new device is able to gain access to the secure enclave by first obtaining a temporary credential from an existing device in the field. The new device presents the temporary credential to the security entity which authenticates, provisions, and if appropriate fully associates the new devices to the secure enclave. The invention also includes a process for creating and distributing the temporary credentials to existing devices in the field including using secure connections to transmit electronic version of the temporary credentials and methods to securely distribute physical copies of the credentials. This invention enables rapid deployment of new devices, or replenishment of lost or damaged devices in the field without compromising the security of the device or the secure enclave. The invention also reduces the resources required, provides a solution that is available at any time, and reduces the technical skill required to add a device to a secure enclave.

### CROSS-REFERENCE TO RELATED APPLICATIONS

The present application is related to and claims priority from prior provisional application Ser. No. 61/632,456 filed Jan. 24, 2012 the contents of which are incorporated herein by reference.

### FIELD OF THE INVENTION

This invention relates generally to the field of securing data, and particularly methods, apparatuses, and systems for adding a communication or computing device to a secure enclave.

### BACKGROUND OF THE INVENTION

Modern electronic communication systems are used prolifically to communicate information in the form of electronic data across extensive wire and wireless communication networks. Private, corporate, and government entities use such networks to communicate sensitive information that require privacy and security. Such networks may include a system of securely associated devices that facilitate communication amongst various communications, computing, or electronic devices deployed in the field. This system of securely associated devices and various communications, computing, or electronic devices, along with the people using the devices, are referred to as a secure enclave.

Each communication, computing, or electronic device must be associated to the secure enclave prior to use. Therefore, each such device must physically be brought into control of a protected area to be authenticated, provisioned, and associated with the secure enclave prior to being deployed to the field for use. This process of authenticating, provisioning, and associating the device with the secure enclave is generally done by an entity responsible for the security of the secure enclave, such as a security officer. This process must be done for each of the millions of communication, computing, or electronic mobile or fixed devices widely in use - such as smart phones, tablet PC's, notebook PC's, desktop PC's, remote monitoring devices, cameras, sensors, or any other device that communicates over a secure enclave. An efficient solution is needed to add such devices to secure enclaves.

Existing methods require the device to be delivered to the protected area for provisioning which delays deployment of the device for field use, or prevents a device already in the field but not part of the secure enclave from joining the secure enclave, since a device cannot be provisioned in the field. Another existing method requires the devices to communicate directly with the secure enclave which may compromise the security and privacy of the device or the secure enclave. Existing methods to add a new device to a secure enclave may impose a delay, or subject the device and secure enclave to outside threats, and require physical interaction with the entity responsible for the security of the secure enclave.

This invention provides novel methods, apparatus, and systems to authenticate, provision, and associate devices with a secure enclave in the field, thus adding the devices to a secure enclave without first having to physically interact with the entity responsible for the security of the secure enclave. This invention enables rapid deployment of new devices, or replenishment of lost or damaged devices in the field without compromising the security of the device or the secure enclave. The invention also reduces the resources required, provides a solution that is available at any time, and reduces the technical skill required to add a device to a secure enclave.

### BRIEF SUMMARY OF THE INVENTION

In one embodiment of the invention a system that adds a new device to a secure enclave comprises a first protected environment including a security entity, secure management console, and a temporary credential-creating device. Next the protected environment is coupled to a secure enclave that may include a collection of coupled existing devices and users. Finally, a new device becomes available to join the secure enclave.

In one embodiment of the invention a process to add a new device to a secure enclave comprises the first step of a new device becoming within close proximity to an existing device that is already a member of the secure enclave. Next, the user of the existing device authenticates the new device. Next, the user of the existing device determines that the new device has an approved purpose to become a member of the secure enclave. Next, the user of the existing device installs the necessary software and temporary credential into the new device. Next, the software installed in the new device enables communication with a remote security server within the secure enclave and transmits the temporary credential. Next, the remote security server authenticates the new device since it recognizes the temporary credential that it previously provided to the existing device. Finally, the remote security server adds the new device to the secure enclave and begins to administrate the new device as it would any other device in its secure enclave.

In another embodiment of the invention a process to create and distribute a temporary credential to an existing device includes the first step of using the temporary credential-creating device to create a credential that the security entity will recognize when a new device attempts to use it. Next, the security entity determines an appropriate process to distribute the temporary credential to an existing device, such process may include sending the temporary credential to the existing device only when the existing device demands the temporary credential via a secure and authenticated connection; or the security entity may create a collection of temporary credentials and store them onto an electronic hardcopy that can be entered into the new device in the field; or the security entity may create the temporary credentials and store them onto a physical hardcopy, such as printed on paper using visible or invisible ink.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a diagram illustrating a system that adds a new device to a secure enclave in accordance with the teachings of the present invention;

FIG. 2 is a diagram of an exemplary embodiment for a process to add a new device to a secure enclave in accordance with the teachings of the present invention;

FIG. 3 is a diagram of an exemplary embodiment for a process to create and distribute a temporary credential to an existing device in a secure enclave in accordance with the teachings of the present invention;

FIG. 4 is a diagram of an exemplary embodiment in which the temporary credential may be printed with invisible ink over a page in a magazine and secretly sent to a person in the secure enclave in accordance with the teachings of the present invention.

### DETAILED DESCRIPTION OF THE INVENTION

The following describes the details of the invention. Although the following description will proceed with reference being made to illustrative embodiments, many alternatives, modifications, and variations thereof will be apparent to those skilled in the art. Accordingly, it is intended that the claimed subject matter be viewed broadly. Examples are provided as reference and should not be construed as limiting. The term “such as” when used should be interpreted as “such as, but not limited to.”

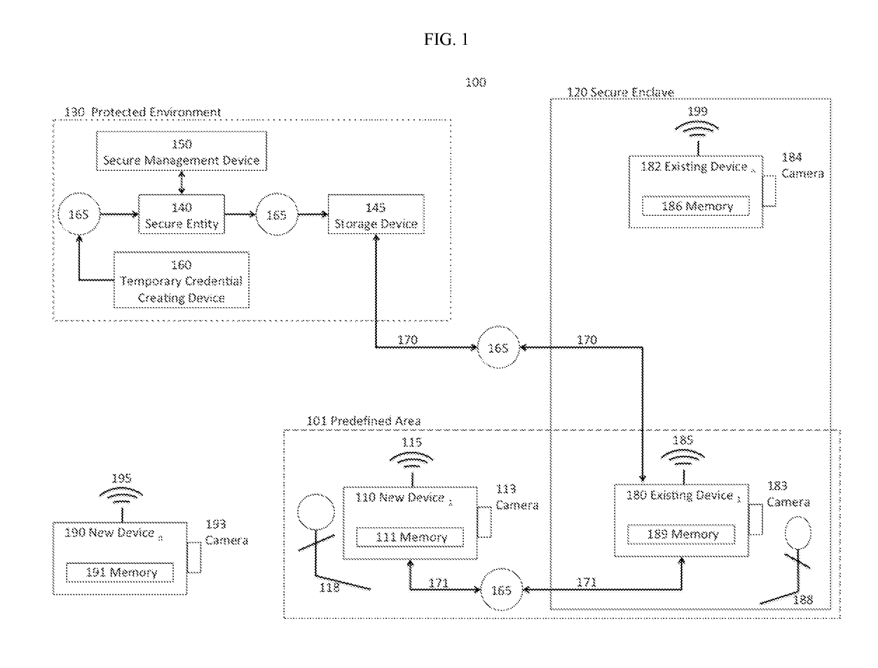

FIG. 1 is a diagram of an exemplary embodiment for a system 100 that adds a new device 110 to a secure enclave 120 comprising a first protected environment 130. The protected environment 130 is a known, secure, physical or virtual location. A security entity 140 is located within the protected environment 130. The security entity 140 is responsible for authenticating, provisioning, and associating devices as members of the secure enclave 120. The security entity 140 may be a person, such as a security officer, or the functions performed by the security entity 140 may be automated and performed by a software program, computer, other electronic device, or machine.

A secure management device 150 may be used to manage the interaction between the security entity 140 and the devices in the secure enclave 120. The secure management device 150 may be a server, router, personal computer, or other device capable of receiving data communicated to and from the devices in the field and the security entity 140. A temporary credential-creating device 160 is also located within the protected environment 130. The security entity 140 uses the temporary credential-creating device 160 to create temporary credentials 165 to distribute to new devices 110 in the field. The temporary credentials 165 may include seed keys, or any other type of credential used by a new device 110 as attestation of qualification when attempting to join the secure enclave 120.

Next the protected environment 130 is coupled 170 to existing devices 180 within a secure enclave 120. The secure enclave 120 includes a collection of existing devices 180 and 182. The secure enclave 120 is designed to provide secure connections between existing devices 180 and 182 of the secure enclave 120, the secure management device 150, and the security entity 140. The existing devices 180 and 182 may include communication, computing, or electronic mobile or fixed devices such as smart phones, tablet PC's, notebook PC's, desktop PC's, remote monitoring devices, cameras, sensors, or any other device that communicates within the secure enclave 120.

Finally, a new device 110 becomes available to join the secure enclave 120. The new member 118 would normally user their new device 110 to engage with the secure management device 150 and, or security entity 140. Because the new device 110 has no direct way to communicate with the secure management device 150 or security entity 140 it must instead first establish a connection 171 with an existing device 180 in the secure enclave 120. The existing device 180 has been either been pre-loaded, or can acquire on demand, temporary credentials from the security entity 140. The connection 171 may be established via a wired or wireless connection. For example, the new device 110 and existing device 180 may establish a wireless connection by means of a wireless communication system. The existing device 180 can then provide the software and temporary credentials to the new device 110 via the established connection 171. It is possible to provide the software and temporary credentials to all existing devices (i.e. existing device 1 180 through existing device n 182); however it may be more practical to limit the software and temporary credentials to fewer existing device 180 for security and manageability reasons.

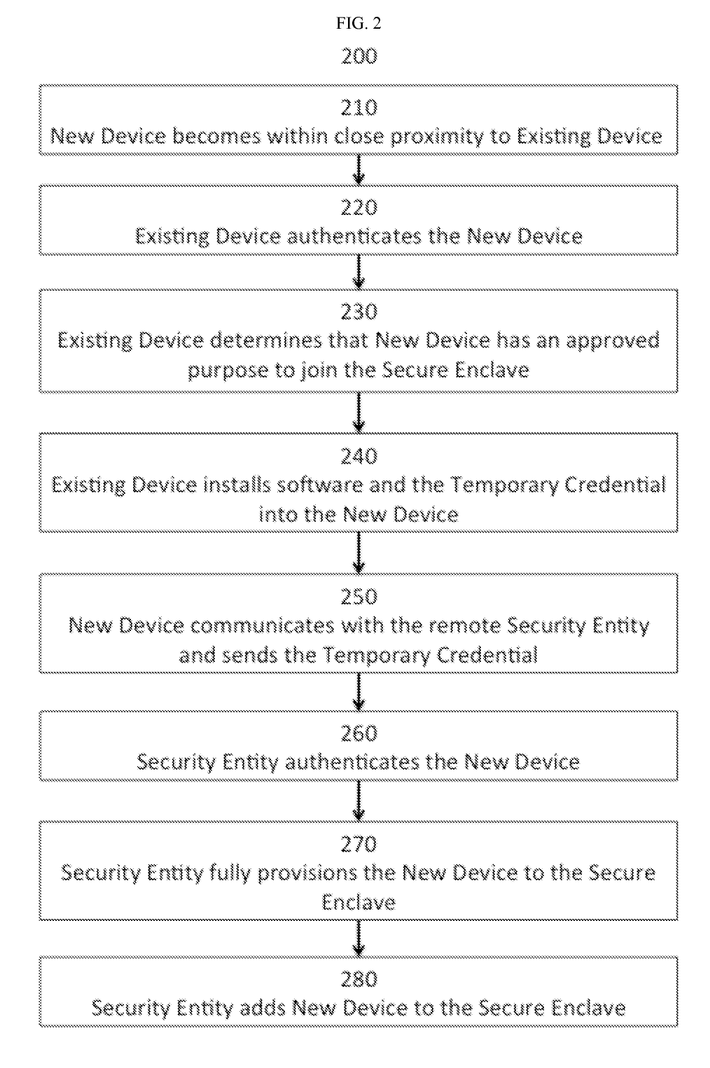

FIG. 2 is a diagram of an exemplary embodiment for a process 200 to add a new device 110 in FIG. 1 to a secure enclave 120 in FIG. 1 comprising the first step of a new device becoming within close proximity 210 to an existing device 180 in FIG. 1 that is already a member of the secure enclave 120 in FIG. 1. The new member 118 in FIG. 1 must get their new device 110 in FIG. 1 close enough to the existing member 188 in FIG. 1 so that the existing member 180 in FIG. 1 can vet the new device 110 in FIG. 1. This may require that the existing member 188 in FIG. 1 be in physical possession of the new device 110 in FIG. 1.

Next, the existing device 180 in FIG. 1 authenticates 220 the new device 110 in FIG. 1. The existing device 180 in FIG. 1 ensures that the new device 110 in FIG. 1 is trusted and authorized to join the secure enclave 120 in FIG. 1. Next, the existing device 180 in FIG. 1 determines that the new device 110 in FIG. 1 has an approved purpose 230 to become a member of the secure enclave 120 in FIG. 1. Next, the existing device 180 in FIG. 1 installs the necessary software and temporary credential 240 into the new device 110 in FIG. 1. The software may include the software and data necessary to establish remote access to the secure management device 150 in FIG. 1 and exchange files and messages in text, audio and/or video formats between the different devices.

Next, the software installed in the new device 110 in FIG. 1 enables the new device 110 in FIG. 1 to automatically communicate and send the temporary credential 250 to the security entity 140 in FIG. 1 within the secure enclave 120 in FIG. 1. Next, the security entity 140 in FIG. 1 authenticates the new device 110 in FIG. 1 since it recognizes the temporary credential that it previously provided to the existing device 180 in FIG. 1. The security entity 140 in FIG. 1 also makes a final determination as to whether the new device 110 in FIG. 1 should be fully provisioned 270 and added to the secure enclave 120 in FIG. 1. Finally, if fully provisioned, the security entity 140 in FIG. 1 adds 280 the new device 110 in FIG. 1 to the secure enclave 110 in FIG. 1 and begins to administrate the new device 110 in FIG. 1 as it would any other device in the secure enclave 120 in FIG. 1. The security entity 140 in FIG. 1 may give the new device permanent key material such as a certificate, or other permanent credential. The security entity 140 in FIG. 1 may also configure the new device 110 in FIG. 1 with detailed information needed to engage within the secure enclave 120 in FIG. 1 such as device type, location, names, ranks, power settings, and security settings.

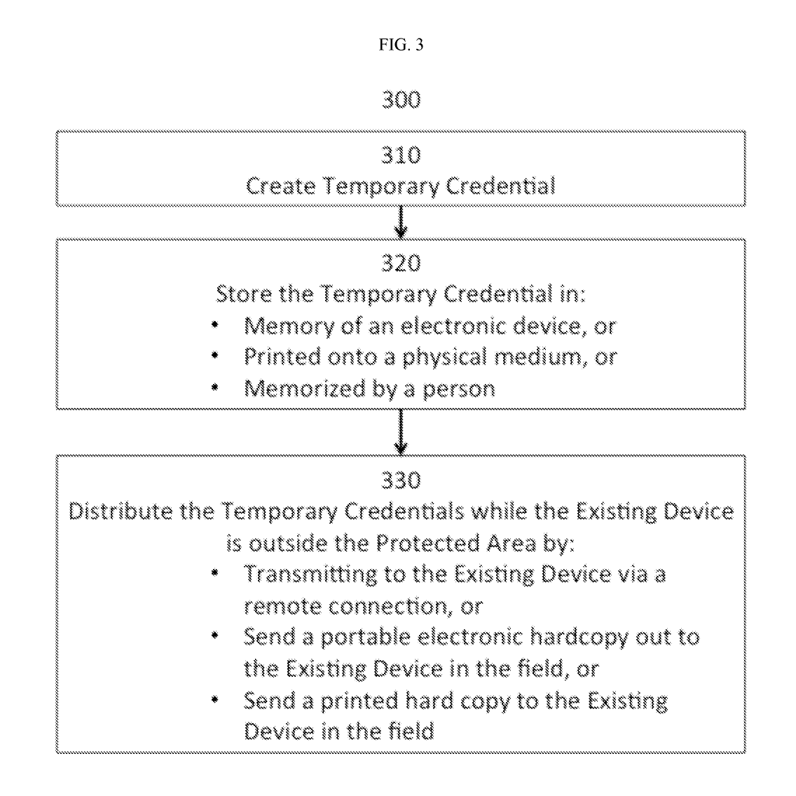

FIG. 3 is a diagram of an exemplary embodiment for a process 300 to create and distribute a temporary credential 165 in FIG. 1 to an existing device 180 in FIG. 1 in a secure enclave 120 in FIG. 1 comprising the first step of using the temporary credential-creating device 160 in FIG. 1 to create 310 temporary credentials 165 in FIG. 1. The security entity 140 in FIG. 1 will use the temporary credential-creating device 160 in FIG. 1 to create any number of unique temporary credentials. The temporary credential 165 in FIG. 1 will be needed by the new device 110 in FIG. 1 to join the secure enclave 120 in FIG. 1 while in the field, or away from the protected environment 130 in FIG. 1. The temporary credential 165 in FIG. 1 may include seed keys, or any other type of credential used by a new device 110 in FIG. 1 as attestation of qualification when attempting to join the secure enclave 120 in FIG. 1. The temporary credential 165 in FIG. 1 may also be encrypted so that only an authorized entity will be able to use the temporary credential 165 in FIG. 1.

Next the temporary credential 165 in FIG. 1 may be stored 320 in an electronic or physical format. For example, the temporary credential 165 in FIG. 1 may be stored within the memory of an electronic device, or printed onto a physical medium such as paper, or a person such as the security officer or other members of the secure enclave may memorize the credential. The information included in the temporary credential 165 in FIG. 1 is sufficient such that the security entity 140 in FIG. 1 will be able to recognize the temporary credential 165 in FIG. 1 as being from a trusted source when a new device attempts to use it. The information included in the temporary credential 165 in FIG. 1 may include a passcode, name, identity, serial numbers, or any other data sufficient for the security entity 140 in FIG. 1 to determine that the new device 110 in FIG. 1 is a trusted entity.

The temporary credential 165 in FIG. 1 may also include features that prevent the temporary credential 165 in FIG. 1 from being misused. For example, the temporary credential 165 in FIG. 1 may include unique data that prevents it from being used more than once. The temporary credential 165 in FIG. 1 may also include data that helps the security entity 140 in FIG. 1 determine where and from which existing device 180 in FIG. 1 the new device 110 in FIG. 1 obtained the temporary credential 165 in FIG. 1. The temporary credential 165 in FIG. 1 may also include a feature that renders the temporary credential 165 in FIG. 1 useless after an expiration date. The security entity 140 in FIG. 1 may use the temporary credential-creating device 160 in FIG. 1 to generate any number of temporary credentials 165 in FIG. 1 needed to support the size and growth of the secure enclave 120 in FIG. 1. The secure enclave 120 in FIG. 1 is expected to increase in size including adding any number of new devices 110 in FIG. 1. After creating temporary credentials 165 in FIG. 1 the security entity 140 in FIG. 1 must get the temporary credentials 165 in FIG. 1 out into the field, i.e. away from the protected environment 130 in FIG. 1, so that new devices 110 & 190 in FIG. 1 can use the temporary credentials 165 in FIG. 1 to be authenticated, provisioned, and associated with the secure enclave 120 in FIG. 1, without the need for the new device 110 in FIG. 1 to enter the protected environment 130 in FIG. 1.

Next, the security entity 140 in FIG. 1 distributes the temporary credential 165 in FIG. 1 to an existing device 180 in FIG. 1 based on the most appropriate manner. The temporary credentials 165 in FIG. 1 have to be distributed to existing devices 180 & 182 in FIG. 1 in the field. In some circumstances the security entity 140 in FIG. 1 will be able to provide the temporary credentials 165 in FIG. 1 to an existing device 180 in FIG. 1 while the existing device 180 in FIG. 1 is in the protected environment 130 in FIG. 1. In such cases the security entity 140 in FIG. 1 may load the temporary credentials 165 in FIG. 1 into the memory of the device, or provide to the person using the existing device 180 in FIG. 1 to memorize, or provide the person with a physical copy of the temporary credential 165 in FIG. 1.

However, in some circumstances the security entity 140 in FIG. 1 may need to distribute temporary credentials 165 in FIG. 1 to existing devices 180 & 182 in FIG. 1 in the field. The security entity 140 in FIG. 1 may send the temporary credential 165 in FIG. 1 to the existing device 180 in FIG. 1 when the existing device 180 in FIG. 1 demands the temporary credential 165 in FIG. 1 in electronic format via a remote, secure and authenticated connection 171 in FIG. 1. The secure entity 140 in FIG. 1 may use a remote connection 171 in FIG. 1 that is encrypted to transmit the temporary credential 165 in FIG. 1 to the existing device 180 in FIG. 1 in the field, or use a non-encrypted connection but encrypt the data containing the temporary credential 165 in FIG. 1, in order to protect the temporary credential 165 in FIG. 1 during transmission. The existing device 180 in FIG. 1 may then receive and decrypt the temporary credential 165 in FIG. 1 in the field.

The security entity 140 in FIG. 1 may also create temporary credentials 165 in FIG. 1 and store them onto a storage device 145 in FIG. 1. The storage device 145 in FIG. 1 may be an electronic hardcopy that can be entered into the existing device 180 in FIG. 1 in the field. For example, the storage device 145 in FIG. 1 may be a portable memory storage device such as a thumb drive, hard disk drive, or compact disk with the temporary credentials 165 in FIG. 1 stored as encrypted data. The security entity 140 in FIG. 1 can then send the storage device 145 in FIG. 1, i.e. the portable electronic hardcopy, to an existing device 180 in FIG. 1 in the field. The existing device 180 in FIG. 1 can then download and decrypt the temporary credential 165 in FIG. 1 for use in the field. Likewise, the security entity 140 in FIG. 1 may create the temporary credential 165 in FIG. 1 and store it onto a storage device 145 in FIG. 1 in the form of a portable physical hardcopy. For example, the storage device 145 in FIG. 1 may be printed-paper, or any physical medium with the temporary credential 145 in FIG. 1 information printed onto the physical medium.

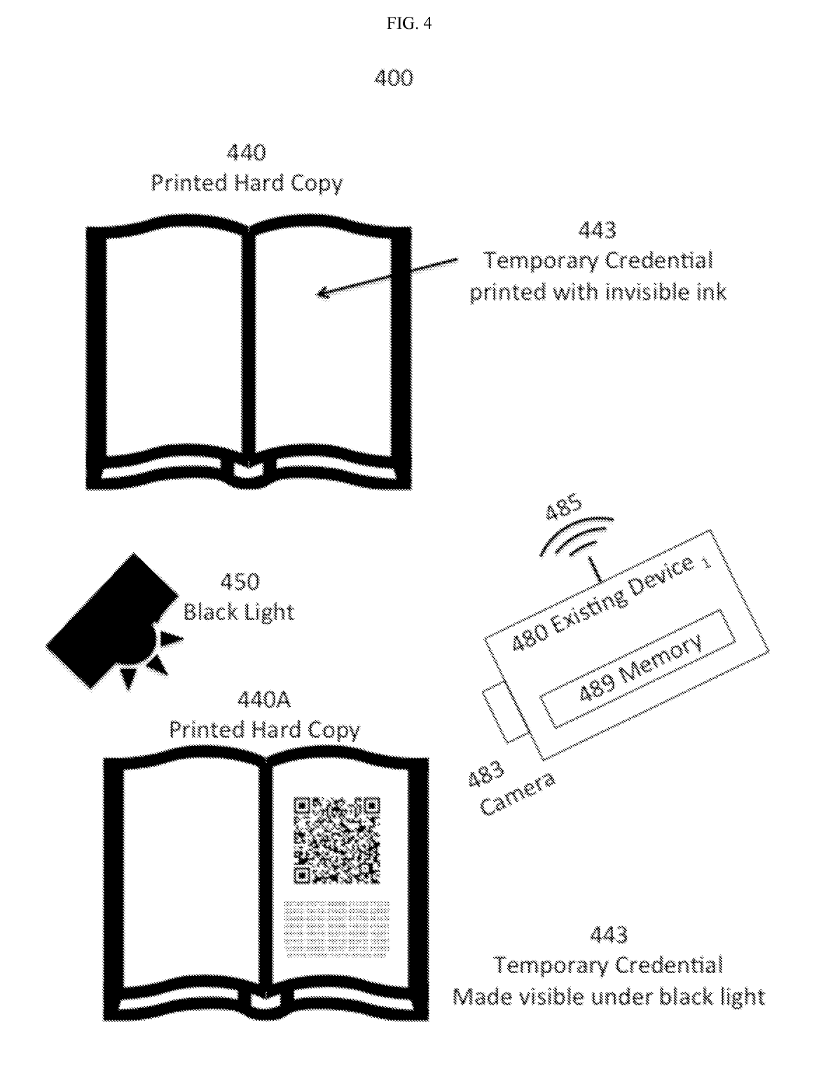

To further protect the temporary credential 145 in FIG. 1 from misuse, the temporary credential 145 in FIG. 1 may be printed with invisible ink that can only be entered into the new device 110 in FIG. 1 once made visible by an illumination process. FIG. 4 is a diagram of an exemplary embodiment for an example in which the temporary credential 445 may be printed with invisible ink over a page 440 such as in a book, journal, magazine, or newspaper and secretly sent to an existing member 188 in FIG. 1 in the secure enclave 120 in FIG. 1. The temporary credential 443 will be invisible and protected from misuse because no one can detect it, but the person 188 in FIG. 1 in the secure enclave 120 in FIG. 1 would be able to detect the temporary credential 443 and copy the visible temporary credential 445 into the existing device 480. The invisible temporary credential 443 can be made visible depending on the type of invisible ink used. For example, exposing the invisible temporary credential 443 made with UV based ink to an ultraviolet light 450 would render the invisible ink visible. Other steganography methods of making ink invisible and visible may also be used such as exposing heat sensitive ink to a heat source, applying reacting agents to chemical reaction inks, and analyzing changes to the surface of paper or other medium. In addition, digital steganography may be used to hide the temporary credential 165 in FIG. 1 inside a digital image. The copy of the visible temporary credential 445 could be made by literally reading and retyping the temporary credential 445 information into the existing device 480, or by using image capture techniques such as an image sensor and image processing technology. For example the person 188 in FIG. 1 could use the camera 483 on the existing device 480 to capture the visible temporary credential 445. Image processing technology such as rasterization, bar code, or quick response codes can be used to quickly capture and process the printed information into electronic data that can be encrypted and stored in the memory of the existing device 480.

The secure entity 140 in FIG. 1 may also revoke or cancel the temporary credential 140 in FIG. 1 on-demand or automatically based on various parameters such as an expiration date, or the existing device 180 in FIG. 1 travelling outside a predefined area 101 in FIG. 1. This helps prevent the temporary credential 165 in FIG. 1 from being misused when lost, stolen, or otherwise to prevent unauthorized use.

Throughout this description, references were made to devices coupled together. Such coupling includes a manner that allows the exchange and interaction of data, such that the operations and processes described may be carried out. For example, the devices may be coupled with electrical circuitry, or through wireless networks that allow the devices to transfer data, receive power, execute the operations described, and provide structural integrity. Reference was also made to interactions between an existing device 180 in FIG. 1 and new device 110 in FIG. 1, secure enclave 120 in FIG. 1, security management device 150 in FIG. 1, security entity 140 in FIG. 1, and protected environment 130 in FIG. 1, however the invention is scalable to be enabled with more devices than described in the specification. For example, any number of existing or new devices, secure enclaves, members, security management devices, security entities, and protected areas may be utilized to enable this invention.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A system to add new devices to a secure enclave comprising:
a protected environment which includes a security entity responsible for authenticating, provisioning, and associating devices as members of the secure enclave, a secure management console used to manage the interaction between the security entity and devices in the secure enclave, and a credential-creating device used to create temporary credentials to distribute to new devices in the field;
a secure enclave which includes existing devices coupled to the protected environment; and
a new device available to join the secure enclave wherein the new device establishes a connection with an existing device to get a temporary credential to join the secure enclave.

2. The system of claim 1, wherein the temporary credential includes seed keys, or other credentials suitable for attestation of qualification needed to join the secure enclave.

3. The system of claim 1, wherein the devices comprise communication, computing, and electronic mobile or fixed devices such as smart phones, tablet PC's, notebook PC's, desktop PC's, remote monitoring devices, cameras, sensors, or any other device that communicates within a secure enclave.

4. A method to add a new device to a secure enclave comprising:
a new device coming within close proximity to an existing device that is already a member of the secure enclave, wherein the existing device acknowledges the new device and determines that the new device has an approved purpose to join the secure enclave;
the existing device installing software and a temporary credential into the new device, wherein the software installed in the new device enables communication with a remote security server and transmits the temporary credential;
the remote security server authenticates the new device by recognizing the temporary credential that the remote security server previously provided to the existing device; and
the remote security server adding the new device to the secure enclave and administrating the new device as it would any other authenticated device in the secure enclave.

5. The method of claim 4, wherein the new device is temporarily in the physical possession of the user of the existing device, so the existing device's user can acknowledge the new device and determine that the new device has an approved purpose to join the secure enclave.

6. The method of claim 4, wherein the software installed in the new device includes the execution software and data necessary to establish a remote connection to the secure management device and exchange files and messages between the devices.

7. The method of claim 4, wherein the security entity gives the new device permanent key material such as a certificate, or other permanent credentials.

8. The method of claim 4, wherein the security entity further configures the new device with information needed to engage with the secure enclave such as device type, location, names, ranks, power settings, and security settings.

9. A method to create and distribute a temporary credential to an existing device for adding new devices to a secure enclave comprising:
using a credential-creating device to create any number of unique temporary credentials;
sending the temporary credentials to the security entity to distribute to existing devices;
the existing devices providing a temporary credential to a new device while the new device is outside the protected environment;
the new device sending the temporary credential to the security entity;
the security entity recognizing the temporary credential; and
granting the new device access to the secure enclave.

10. The method of claim 9, wherein the temporary credential is encrypted so that only an authorized device will be able to use the temporary credential.

11. The method of claim 9, further comprising sending the temporary credential to the existing device only when the existing device demands the temporary credential via a secure and authenticated connection.

12. The method of claim 9, wherein the credential-creating device creates temporary credentials and stores the temporary credentials within a portable electronic hardcopy that can be delivered to devices in the field such as a thumb drive, hard disk drive, or compact disk with the temporary credentials stored as encrypted data.

13. The method of claim 9, wherein the credential-creating device creates the temporary credentials and stores them on a portable physical hardcopy.

14. The method of claim 13, wherein the temporary credentials are printed on a portable physical medium such as paper.

15. The method of claim 14, wherein steganography methods of making ink invisible and visible are used to print the temporary credentials, such as using UV based ink and ultraviolet lights to render the invisible ink visible, exposing heat sensitive ink to a heat source, applying reacting agents to chemical reaction inks, and analyzing changes to the surface of paper or other medium.

16. The method of claim 9, wherein digital steganography is used to hide the temporary credential inside a digital image.

17. The method of claim 9, wherein image capture techniques such as an image sensor and image processing technology on the devices are used to capture the visible temporary credential.

18. The method of claim 17, wherein image processing technology such as rasterization, bar code, or quick response codes are used to quickly capture and process the visible temporary credential into electronic data.

19. The method of claim 9, wherein the temporary credential includes information such as passcode, name, identity, serial numbers, or any other data sufficient for the security entity to determine that the new device is a trusted entity.

20. The method of claim 9, wherein the secure entity may revoke and cancel the temporary credential automatically based on various parameters such as an expiration date or a device travelling outside a predefined area.
